(19) United States
(12) Patent Application Publication
(10) Pub. No.: US 2007/0136257 A1
(43) Pub. Date: Jun. 14, 2007

(54) Information processing apparatus, metadata management server, and metadata management method

(75) Inventor: Junichi Yoshizawa, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/633,486

(22) Filed: Dec. 5, 2006

(30) Foreign Application Priority Data
Dec. 6, 2005 (JP) 2005-352248

(51) Int. Cl. G06F 17/30

(52) U.S. Cl. 707/3

(57) ABSTRACT

According to one embodiment, there is provided an information processing apparatus including a storing unit which stores moving image contents. A scene searching key transmitting unit transmits, to a metadata management server via a network, a scene searching key for searching for a scene from the moving image contents stored in the storing unit. A metadata obtaining unit obtains, from the metadata management server, a result of searching by another information processing apparatus with respect to the moving image contents based on the scene searching key. The result is obtained as metadata.

### CROSS-REFERENCE TO RELATED APPLICATIONS

This application is based upon and claims the benefit of priority from Japanese Patent Application No. 2005-352248, filed Dec. 6, 2005, the entire contents of which are incorporated herein by reference.

### BACKGROUND

1. Field

One embodiment of the invention relates to an information processing apparatus processing moving image, a metadata management server managing metadata related to moving image, an information processing system, and method of using metadata related to moving image.

2. Description of the Related Art

Various means for supplying metadata to moving image contents have been developed (for example, Japanese Patent Application KOKAI Publication 2005-072826).

In Japanese Patent Application KOKAI

Publication No. 2005-072826, a system is proposed which receives, as broadcasting data which is broadcasted in digital broadcasting, video/audio contents, metadata including search information for searching the video/audio contents, and data broadcasting contents which defines the structure of a display screen. The display screen is generated in a receiving apparatus. A viewer can select, on the display screen, a desired scene from the received data broadcasting.

Additionally, in the current television broadcasting programs, electronic program guides called “EPG” are provided to viewers from broadcasting stations or predetermined organizations. Metadata of a program, as represented by EPG, is used for managing, for example, a recorded television program. EPG provides information such as a program name, a genre, performers, and the like.

On the other hand, recently, DVD recorders with a hard disk drive and personal computers having a television tuner function which are capable of performing longtime recording have been widely used. Thus, it has become common for a user at home to continuously record a large amount of contents for a long time, and to afterward select only desired contents from the recorded contents. In such a usage, it is difficult to view the recorded contents for a long time. Thus, there is need for reproducing only desired scenes.

Therefore, an intelligent searching technique is drawing attention as means for solving such a problem. Here, the intelligent searching technique refers to a technique which performs pattern matching with respect to voice, images, etc. over the entire moving image contents, and extracts the matched portions. Specific examples of the intelligent searching technique are given below.

(Example 1) character recognition: for example, only “scenes including the characters ‘prices’ in a telop” are extracted from a program.

(Example 2) voice recognition: for example, only “scenes including a loud cheer of audience” are extracted from a program.

(Example 3) image recognition: for example, only “scenes including images of a person A” are extracted from a program.

By performing search with the use of pattern matching in this manner, it is possible to perform an advanced search as mentioned above.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a general configuration of an information processing system according to an embodiment of the invention;

FIG. 2 is an exemplary block diagram showing an exemplary configuration of an information processing apparatus which can be used as a client device in the information processing system shown in FIG. 1;

FIG. 3 is an exemplary diagram showing an exemplary configuration of a scene searching key which can be used in the information processing system shown in FIG. 1;

FIG. 4 is an exemplary diagram showing an exemplary configuration of metadata which can be used in the information processing system shown in FIG. 1;

FIG. 5 is an exemplary diagram showing an exemplary configuration of a scene selection screen which can be used in the information processing apparatus;

FIG. 6 is an exemplary block diagram showing another exemplary configuration of an information processing apparatus which can be used as a client device in the information processing system shown in FIG. 1;

FIG. 7 is an exemplary block diagram showing an exemplary configuration of a metadata management server which can be used in the information processing system shown in FIG. 1; and

FIG. 8 is an exemplary flowchart for explaining an exemplary procedure of the information processing system shown in FIG. 1.

### DETAILED DESCRIPTION

Various embodiments according to the invention will be described hereinafter with reference to the accompanying drawings. In general, according to one embodiment of the invention, there is provided an information processing apparatus including: a storing unit which stores moving image contents; a scene searching key transmitting unit which transmits, to a metadata management server via a network, a scene searching key for searching for a scene from the moving image contents stored in the storing unit; and a metadata obtaining unit which obtains, from the metadata management server, a result of searching by another information processing apparatus with respect to the moving image contents based on the scene searching key, the result being obtained as metadata.

According to an embodiment of the invention, an information processing system is realized which builds a system of utilizing metadata by user-participating intelligent searching, and which includes a scene searching function capable of performing more flexible scene searching requested by a user.

As for the searching method using pattern matching, which is described in “Description of the Related Art”, it is generally necessary to perform processing on the entire contents more or less depending on the methods. Hence, an extremely long processing time is required. For example, it may take one hour for an intelligent searching process with respect to a two-hour recorded program. However, this is far from being convenient for a user who desires to see only the scenes searched for in the recorded program.

Thus, if a user-participating metadata management server is built, and search results of intelligent searching by the user are accumulated in the server by the user, it is possible to reduce a search response time by reusing the search results by other users.

In addition, there is a problem of copyright, etc. when moving images are transmitted and received between users. However, if only metadata, which is a search result, is transmitted and received, it is possible to reduce such a problem of copyright.

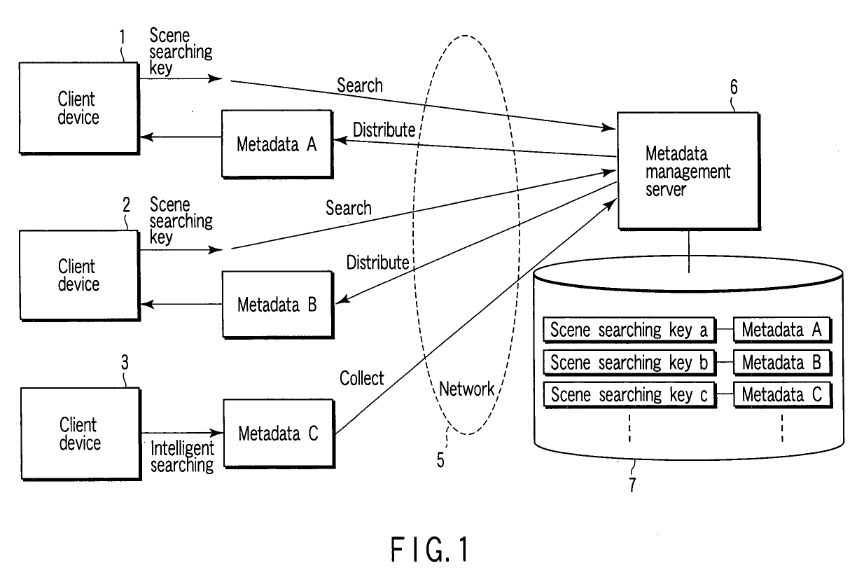

FIG. 1 shows an exemplary configuration of an information processing system according to an embodiment of the invention.

The information processing system according to the embodiment includes a plurality of client devices 1, 2 and 3, and a metadata management server 6 forming a metadata accumulating server, which is coupled to the client devices 1, 2 and 3 via a network 5.

The metadata management server 6 is provided with a database 7 which saves and manages a scene searching key for searching for a scene of moving contents and metadata specifying the scene of the moving contents in an associated manner. The metadata is generated by performing the intelligent searching process on the moving contents.

Each of the client devices 1, 2 and 3 includes a “searching” function which issues a search request to the metadata management server 6 by using the scene searching key.

The “searching” function is realized by operating a client device i (i=1, 2 or 3) by a user so as to input, for example, a scene searching key indicating characteristics of a desired scene included in stored (recorded) contents, and transmitting the scene searching key to the metadata management server 6 via the network 5.

For example, as for the stored contents, the scene searching key may be, for example: a scene searching key for searching for a scene including a specific image pattern such as a person A; a scene searching key for searching for a scene including a specific character string pattern such as prices, news, a proper noun, etc.; or a scene searching key for searching for a scene including a specific voice pattern such as a tone quality, cheer, etc. The scene searching key as mentioned above is input and transmitted to the metadata management server 6 via the network 5.

The metadata management server 6 includes a “distributing” function of providing, to the client device i which issues the search request and transmits the scene searching key, metadata which is searched for based on the scene searching key received from the client device i via the network 5. The “distributing” function is realized by referring to the database 7 by the metadata management server 6 every time the scene searching key is received from the client device i, searching pairs of a scene searching key and metadata stored in the database 7 for the metadata paired with the received scene searching key, and providing (distributing) the searched metadata to the client device i, which issues the search request (transmits the scene searching key).

For example, when the scene searching key for searching for a scene including a specific image pattern is received, the database 7 is searched by the received scene searching key. From the database 7, metadata is obtained which is stored in association with the scene searching key, and specifies, for example, the recording start time (position) and recording time of the scene. The metadata is provided (distributed) to the client device i, which issues the search request (transmits the scene searching key).

Further, the metadata management server 6 includes a function of “collecting”, from the client device, and storing, in the database 7, the metadata generated (extracted) by the intelligent searching by the user. The client device includes a function of generating metadata.

For example, in the case where each of the client devices 1, 2 and 3, or one or more of the client devices 1, 2 and 3 include the above-mentioned intelligent searching function, scene searching is performed, by the scene searching key which is input by the user, on moving image contents stored in the client devices. The metadata, which is obtained as the searched result and specifies information such as the recording start time and recording time, etc., is transmitted from one or more of the client devices 1, 2 and 3 to the metadata management server 6. In the case shown in FIG. 1, the client device 3 includes the intelligent searching function. The metadata management server 6 obtains the metadata generated by the one or more client devices as mentioned above via the network 5. Further, the obtained metadata is stored and accumulated in the database 7 so that the obtained metadata can be used for a scene searching request from other client devices (other users). With the metadata storing function, it is possible to build a database of metadata obtained by the user-participating metadata storing process, and to realize a system including highly flexible scene searching function which allows metadata stored by one user to be used by the other users.

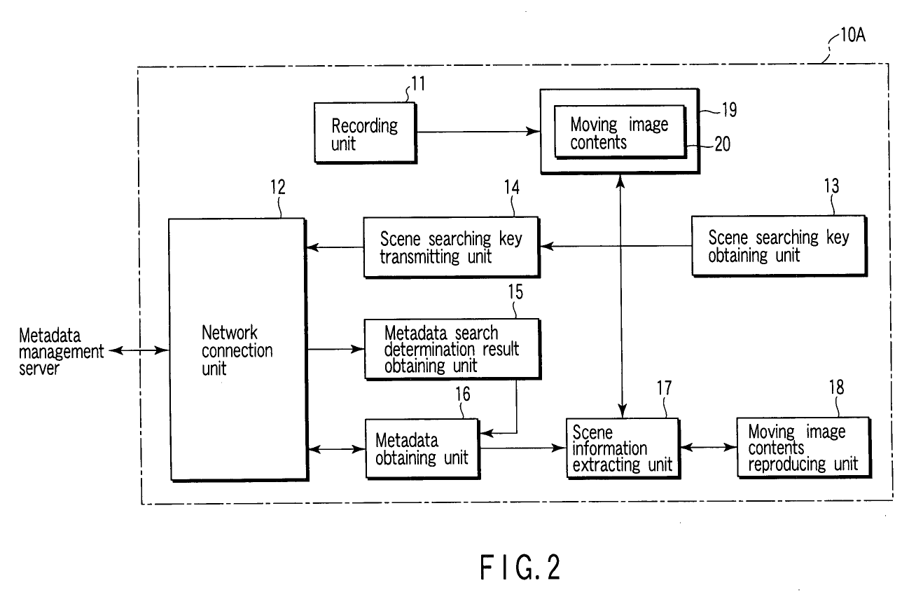

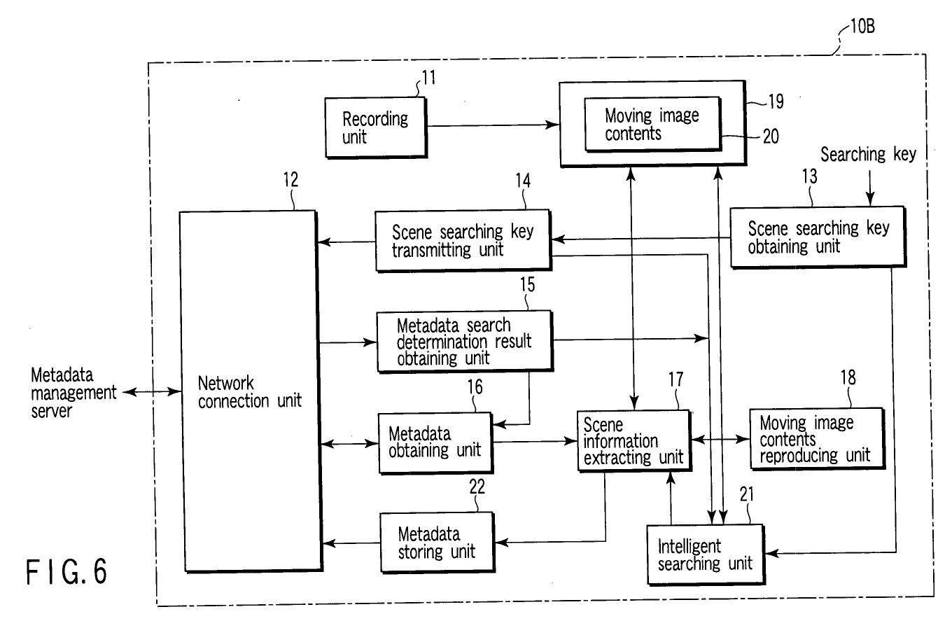

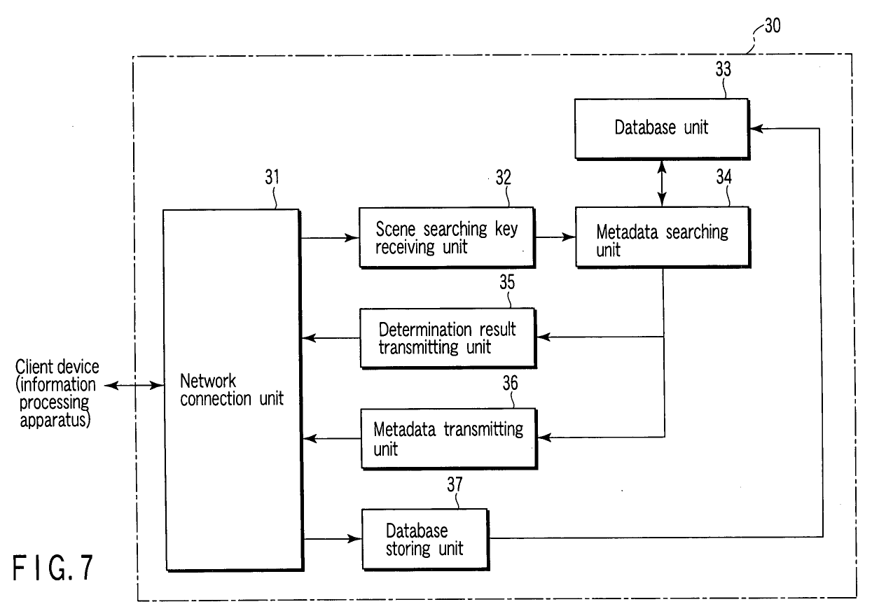

Each of the client devices 1, 2 and 3 in the above-mentioned information processing system shown in FIG. 1 is realized by, for example, an information processing apparatus shown in FIG. 2 or 6 described later. Additionally, the metadata management server 6 is realized by, for example, a metadata management server shown in FIG. 7 described later.

FIG. 2 shows an exemplary configuration of an information processing apparatus 10A according to an embodiment of the invention. The information processing apparatus 10A can be used as the client device 1 or 2 in the information processing system shown in FIG. 1. The information processing apparatus 10A shown in FIG. 2 can be realized by, for example, a general-purpose personal computer, or a hardware configuration in an image processing device having an information processing function. In the configuration shown in FIG. 2, illustration is omitted for an input device such as a pointing device and a keyboard operated by the user, a display device for displaying reproduced images, etc., and hardware elements such as a CPU for executing programs including an application program.

The information processing apparatus 10A includes a recording unit 11, a network connection unit 12, a scene searching key obtaining unit 13, a scene searching key transmitting unit 14, a metadata search determination result obtaining unit 15, a metadata obtaining unit 16, a scene information extracting unit 17, a moving image contents reproducing unit 18, a storing unit, etc.

The recording unit 11 receives television broadcasting, and records the received broadcast program in the storing unit 19. The storing unit 19 is a storing medium such as a hard disk drive, a DVD, or the like. The recording unit 11 stores, in the storing unit 19, moving image contents 20 of the received broadcast program. The moving image contents 20 stored in the storing unit 19 includes, for example, image information (video information), voice information received concurrently with the image information, and/or other information.

The network connection unit 12 realizes a physical/logical connection with a network. The network connection unit 12 establishes a network connection with the metadata management server 6 which manages scene searching keys and metadata in an associated manner with respect to various kinds of moving image contents.

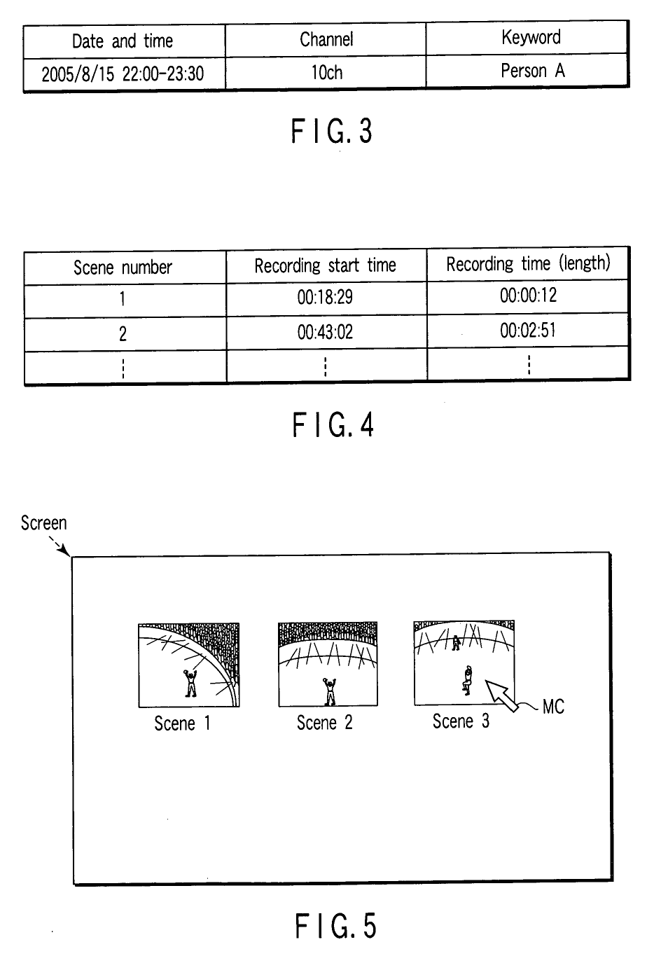

The scene searching key obtaining unit 13 obtains a scene searching key which is input by the user. For example, when the user inputs a scene searching key for extracting a specific scene from the moving image contents 20 stored in the storing unit 19, the scene searching key obtaining unit 13 obtains the scene searching key input by the user (see FIG. 3, which will be described later).

The scene searching key transmitting unit 14 transmits the scene searching key obtained by the scene searching key obtaining unit 13 to the metadata management server 6 on the network 5 via the network connection unit 12.

The metadata search determination result obtaining unit 15 obtains, from the metadata management server 6 on the network 5, a metadata search determination result with respect to the scene searching key transmitted by the scene searching key transmitting unit 14.

The metadata obtaining unit 16 obtains metadata from the metadata management server 6 on the network 5. When the metadata search determination result obtaining unit 15 obtains, from the metadata management server 6, a determination result indicating that metadata exists with respect to the scene searching key transmitted by the scene searching key transmitting unit 14, the metadata obtaining unit 16 obtains, from the metadata management server 6, the metadata stored and associated with the scene searching key (see FIG. 4, which will be described later).

Based on the metadata obtained by the metadata obtaining unit 16, the scene information extracting unit 17 extracts a scene specified in the metadata from the moving image contents 20 stored in the storing unit 19. Further, the scene information extracting unit 17 presents (displays) the scene extracted form the moving image contents 20 to the user by using a scene selection screen. For example, when a plurality of items of metadata associated with the above-mentioned scene searching key exist, a plurality of scenes specified by the plurality of items of metadata are selectably presented to the user in the scene selection screen with respective predetermined sizes (e.g., thumbnails) (see FIG. 5, which will be described later).

Based on the scene extracted by the scene information extracting unit 17 and selected by the user (assuming the scene selected by the user as a reproduction start point), the moving image contents reproducing unit 18 reproduces the moving image contents 20 stored (recorded) in the storing unit 19.

Referring to FIGS. 3 through 5, a description is given of an operation of the information processing apparatus 10A shown in FIG. 2.

First, the user provides, to the scene searching key obtaining unit 13, one or more keywords of a scene (scene searching key) which is a searching target of the intelligent searching with respect to the moving image contents 20 stored in the storing unit 19. It is possible to input the scene searching key from, for example, a keyboard, a pointing device, a remote controller (not shown), and the like. Various configurations may be applied to the scene searching key. For example, in order to represent “a scene including a person A in a program broadcasted on channel 10 from 22:00 to 23:30”, a scene searching key which sets, for example, “date and hour”, “channel” and “keyword” as shown in FIG. 3 may be generated.

The scene searching key thus generated is transmitted, as metadata, to the metadata management server 6 from the scene searching key transmitting unit 14 via the network connection unit 12.

Upon reception of the scene searching key from the information processing apparatus 10A via the network 5, the metadata management server 6 searches the database 7 by the scene searching key, and determines whether or not metadata associated with the scene searching key is stored in the database 7 with respect to the moving image contents. The determination result is transmitted to the information processing apparatus 10A, which transmits the above-mentioned scene searching key.

The metadata search determination result obtaining unit 15 checks the determination result received from the metadata management server 6. When it is confirmed that the metadata associated with the scene searching key exists in the database 7 of the metadata management server 6, the confirmation is notified to the metadata obtaining unit 16.

Upon reception of the notification from the metadata search determination result obtaining unit 15, the metadata obtaining unit 16 requests the metadata management server 6 of the metadata associated with the scene searching key.

Upon reception of the request, the metadata management server 6 searches the database 7 by the scene searching key included in the request, and obtains the metadata associated with the scene searching key. The obtained metadata is transmitted to the information processing apparatus 10A which issues the request.

Upon reception of the metadata from the metadata management server 6, the metadata obtaining unit 16 transmits the obtained metadata to the scene information extracting unit 17.

Here, the metadata obtained by the metadata obtaining unit 16 indicates the portion (e.g., scene) of the stored moving image contents 20 corresponding to the scene searching key provided by the user. For example, the metadata may include time information of a partial scene corresponding to the contents of the scene searching key. FIG. 4 shows an exemplary configuration of the metadata. In the exemplary metadata shown in FIG. 4, with respect to the entire moving image contents, scene numbers consecutively assigned to respective scenes which are search targets, recording start times of the scenes, and the recording times are associated to each other. The metadata obtained by a single scene searching key is not limited to one item of metadata. In the case where a plurality of relevant scenes exist, a plurality of items of metadata are obtained.

Based on the metadata obtained by the metadata obtaining unit 16, the scene information extracting unit 17 extracts the scene corresponding to the time information included in the metadata from the moving image contents stored in the storing unit 19, and displays the extracted scene on the scene selection screen. Similar to a selection screen using icons, for example, the extracted scene can be represented by a thumbnail which is a reduced screen of the scene. FIG. 5 shows an exemplary screen image of the scene selection screen generated by the scene information extracting unit 17. FIG. 5 shows an exemplary scene selection screen in the case where three items of metadata are searched with respect to one scene searching key.

When the user selects a desired scene from the scene selection screen, the moving image contents reproducing unit 18 reproduces the stored contents 19 by assuming the selected scene as the reproduction start point.

In this manner, it is possible to effectively extract a desired scene by using the metadata provided in the metadata management server 6. On this occasion, it is unnecessary to perform the intelligent searching with respect to the moving image contents 20 within the client device 10A.

FIG. 6 shows an exemplary configuration of an information processing apparatus 10B according to an embodiment of the invention. The information processing apparatus 10B can be used as the client device 3 in the information processing system shown in FIG. 1. As for the elements of the information processing apparatus 10B shown in FIG. 6, those elements corresponding to the elements in the information processing apparatus 10A shown in FIG. 2 are designated by the same reference numerals, and a detailed description thereof will be omitted.

The information processing apparatus 10B includes an intelligent searching unit 21 and a metadata storing unit 22 in addition to the recording unit 11, the network connection unit 12, the scene searching key obtaining unit 13, the scene searching key transmitting unit 14, the metadata search determination result obtaining unit 15, the metadata obtaining unit 16, the scene information extracting unit 17, the moving image contents reproducing unit 18, the storing unit 19, etc.

The intelligent searching unit 21 detects (searches for) a scene which satisfies a given searching condition (which matches a scene searching key) by performing searching according to the pattern matching techniques such as the image recognition, the character recognition, and the voice recognition as mentioned above. Based on the detection result, the intelligent searching unit 21 generates metadata (see FIG. 4).

Examples of the intelligent searching by the intelligent searching unit 21 are as follows. It is detected that the character string of, for example, “person A” is included in screens as a caption (character recognition). A voice output portion including, for example, “person A” is detected (voice recognition). Image data of “person A” is prepared in advance, and a screen including the person A is detected by comparing images of persons in the moving image contents 20 with the image data of the person A (image recognition). The intelligent searching unit 21 generates metadata by performing the intelligent searching by using all of or one of the pattern matching techniques. An arbitrary conventional method can be used for the character recognition, voice recognition, and image recognition.

The metadata storing unit 22 performs a process which transmits, to the metadata management server 6 on the network 5, and stores, in the database 7 of the metadata management server 6, the metadata generated by the intelligent searching unit 21 together with the scene searching key.

Referring to FIG. 3 through 5, a description is given of an operation of the information processing apparatus 10B.

As in the case of the information processing apparatus 10A, the user provides, to the scene searching key obtaining unit 13, one or more keywords of a scene (a scene searching key, see FIG. 3) which is a searching target of the intelligent searching. The scene searching key transmitting unit 14 transmits, via the network connection unit 12, the scene searching key obtained by the scene searching key obtaining unit 13 to the metadata management server 6 coupled to the network 5.

Upon reception of the scene searching key from the information processing apparatus 10B, the metadata management server 6 searches the database 7 by the scene searching key, and determines whether or not metadata associated with the scene searching key is stored in the database 7. The determination result is transmitted, as the metadata, to the information processing apparatus 10B, which transmits the scene searching key.

Here, in the case where metadata associated with the scene searching key exists in the database 7 with respect to moving image contents identical to the moving image contents 20, the process which is the same as that performed in the information processing apparatus 10A is performed.

The metadata search determination result obtaining unit 15 checks the determination result received from the metadata management server 6. When it is confirmed that metadata associated with the scene searching key does not exist in the database 7 of the metadata management server 6, the metadata search determination result obtaining unit 15 notifies the intelligent searching unit 21 of the confirmation.

Upon reception of the notification, the intelligent searching unit 21 performs the intelligent searching with respect to the moving image contents stored (recorded) in the storing unit 19. The metadata (see FIG. 4) extracted in the intelligent searching process is transmitted to the scene information extracting unit 17. Based on the metadata generated by the intelligent searching unit 21, the scene information extracting unit 17 extracts and displays, on a scene selection screen (see FIG. 5), a scene corresponding to time information of the moving image contents 20 stored in the storing unit 19. When the user selects a desired scene from the scene selection screen, the moving image contents reproducing unit 18 reproduces the stored contents 19 by assuming the selected scene as the reproduction start point.

On the other hand, when the metadata is generated, the intelligent searching unit 21 transmits, to the metadata storing unit 22, the generated metadata together with the scene searching key. The metadata storing unit 22 issues a storing request for storing the metadata and the scene searching key in the database 7 by transmitting, to the metadata management server 6 via the network 5, the metadata received from the intelligent searching unit 21 together with the scene searching key. Upon reception of the storing request, the metadata management server 6 stores, in the database 7, the metadata according to the storing request by associating the metadata with the scene searching key.

In this manner, the database of metadata obtained by the user-participating intelligent searching is built in the metadata management server 6.

That is, the metadata management server 6 stores metadata generated by the intelligent searching performed by a large number of users who are dispersed on the network 5. Accordingly, it is possible for a large number of users on the network 5 to use the metadata.

FIG. 7 shows an exemplary configuration of a metadata management server 30 according to an embodiment of the invention. The metadata management server 30 can be used as the metadata management server 6 in the information processing system shown in FIG. 1.

The metadata management server 30 includes a network connection unit 31, a scene searching key receiving unit 32, a database unit 33, a metadata searching unit 34, a determination result transmitting unit 35, a metadata transmitting unit 36, a database storing unit 37, etc.

The network connection unit 31 provides a function of establishing a connection with a network. The network connection unit 31 provides (distributes) metadata to a plurality of client devices which are dispersed on a network and include the functions of, for example, information processing apparatus 10B shown in FIG. 6. The network connection unit 31 performs transfer control of various kinds of data in collecting metadata from the client devices.

The scene searching key receiving unit 32 receives a scene searching key (see FIG. 3) transmitted from a client device coupled to the network connection unit 31 via a network.

The database unit 33 includes pairs of a scene searching key and metadata. The database unit 33 is accessed by the database storing unit 37, and stores and manages metadata obtained by the database storing unit 37 by associating the metadata with a scene searching key. Further, the database unit 33 is accessed by the metadata searching unit 34, and provides metadata to the metadata searching unit 34.

Based on a scene searching key received by the network connection unit 31 from a client device, the metadata searching unit 34 searches the database unit 33 to determine whether or not metadata corresponding to the scene searching key is already stored.

The determination result transmitting unit 35 transmits (sends back) the searched result of the metadata searching unit 34 to the client device which issues the scene searching key.

In the case where the metadata satisfying the request (the scene searching key) from the client device exists in the database unit 33, the metadata transmitting unit 36 transmits (sends back) the metadata to the client device which transmits the scene searching key.

Upon reception of a request for storing metadata from a client device, the database storing unit 37 stores, in the database unit 33, the metadata as a new entry by associating the metadata with a scene searching key.

A description is given of an operation of the metadata management server 30 shown in FIG. 7 described above.

Upon reception of a scene searching key from a client device coupled to the network, the scene searching key receiving unit 32 transmits the scene searching key to the metadata searching nit 34.

Upon reception of the scene searching key from the scene searching key receiving unit 32, the metadata searching unit 34 accesses the database unit 33, searches for metadata corresponding to the scene searching key, and determines whether or not such metadata is stored in the database unit 33. The data of the determination result is transmitted to the determination result transmitting unit 35.

The determination result transmitting unit 35 transmits, via the network connection unit 31, the data of the determination result received from the metadata searching unit 34 to the client device which transmits the scene searching key.

In addition, upon reception of an obtaining request for metadata including a scene searching key from a client device coupled to the network, the scene searching key receiving unit 32 transmits the obtaining request to the metadata searching unit 34.

Upon reception of the obtaining request for metadata from the scene searching key receiving unit 32, the metadata searching unit 34 searches the database unit 33 by the scene searching key, obtains metadata associated with the scene searching key, and transmits the metadata to the metadata transmitting unit 36.

The metadata transmitting unit 36 transmits, via the network connection unit 31, the metadata received from the metadata searching unit 34 to the client device which transmits the scene searching key.

Additionally, upon reception of a request for storing metadata from client devices dispersed on the network, the database storing unit 37 stores the metadata in the database unit 33 by associating the metadata with a scene searching key.

In this manner, the database unit 33 storing the metadata generated through the intelligent searching by a large number of users who are dispersed on the network is built in the metadata management server 30. Thus, it is possible to provide a mechanism which allows a large number of users on the network to use the metadata.

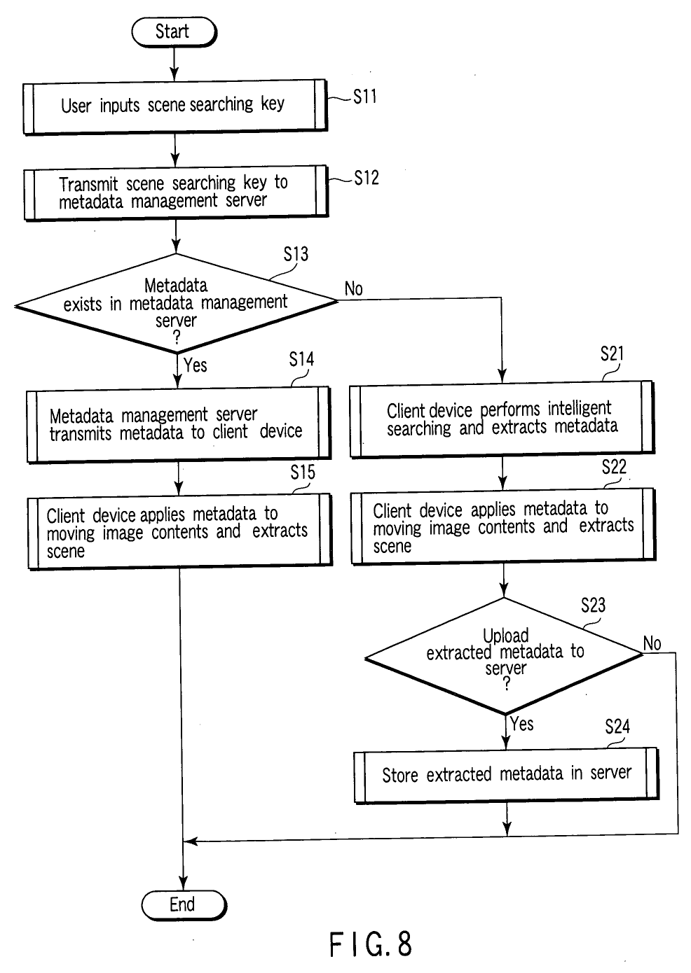

FIG. 8 shows an exemplary procedure of an information processing system using the above-mentioned information processing apparatus and the metadata management server. Here, a description is given of an operation/process of a network system including the information processing apparatus 10B shown in FIG. 6 and the metadata management server 30 shown in FIG. 7. The description is already given above of the internal operation of each of the information processing apparatus 10B, which is a client device, and the metadata management server 30. Thus, the description hereinafter will be given by focusing on communication between the information processing apparatus 10B and the metadata management server 30.

First, a user inputs a scene searching key to the information processing apparatus (hereinafter referred to as “the client device”) 10B (S11). The information processing apparatus 10B transmits the input scene searching key to the metadata management server 30 (S12).

Upon reception of the scene searching key from the client device 10B, the metadata management server 30 searches the database (the database unit 33) for the received scene searching key, and determines whether or not metadata corresponding to the received scene searching key is already stored in the database (S13).

Here, when the metadata corresponding to the received scene searching key is already stored in the database (Yes in S13), the fact is notified to the client device 10B, and when a request for obtaining metadata is received from the client device 10B, metadata associated with the scene searching key is extracted from the database (searched from the database), and the metadata is transmitted to the client device 10B (S14).

Upon obtaining the metadata from the metadata management server 30, the client device 10B performs scene searching, by using the metadata, with respect to the moving image contents stored (recorded) in the storing unit 19, and reproduces the moving image contents stored in the storing unit 19 by assuming the searched scene as the reproduction start point (Si5).

In addition, in the determination of whether or not the metadata corresponding to the received scene searching key is already stored in the database (S13), when the metadata corresponding to the received scene searching key is not stored in the database (No in S13), the fact is notified to the client device 10B.

Upon reception of the notification from the metadata management server 30, the client device 10B performs the intelligent searching with respect to the moving image contents stored in the storing unit 19, extracts metadata by the intelligent searching, performs scene searching with respect to the moving image contents stored in the storing unit 19 by using the extracted metadata, and reproduces the moving image contents stored in the storing unit 19 by assuming the searched scene as the reproduction start point (S22).

Further, it is determined whether or not to upload the extracted metadata to the metadata management server 30 (S23). When the user inputs a request for storing metadata (YES in S23), the client device 10B issues a request for storing metadata by transmitting the extracted metadata to the metadata management server 30 together with the scene searching key, and the metadata extracted by the intelligent searching is stored in the metadata management server 30 by associating the extracted metadata with the scene searching key (S24).

In the case where the network system includes the metadata management server 30 and the information processing apparatus 10A shown in FIG. 2 instead of the information processing apparatus 10B shown in FIG. 6, the processes in S11 through S15 shown in FIG. 8 are similarly performed. However, when the metadata corresponding to the scene searching key is not stored in the database (NO in S13), the metadata management server 30 notifies the information processing apparatus 10A that the metadata does not exist, and the process ends.

In this manner, the database storing the metadata generated through the intelligent searching by a large number of users (client devices) who are dispersed on the network is built in the metadata management server 30. Thus, it is possible to build a more flexible information processing system (metadata collecting/distributing system) which allows a large number of users (client devices) on the network to use the metadata.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a storing unit which stores moving image contents;
a scene searching key transmitting unit which transmits, to a metadata management server via a network, a scene searching key for searching for a scene from the moving image contents stored in the storing unit; and
a metadata obtaining unit which obtains, from the metadata management server, a result of searching by another information processing apparatus with respect to the moving image contents based on the scene searching key, the result being obtained as metadata.

2. The information processing apparatus according to claim 1, further comprising:
a scene extracting unit which extracts, based on the metadata obtained by the metadata obtaining unit, the scene from the moving image contents stored in the storing unit; and
a reproducing unit which reproduces the scene extracted by the scene extracting unit.

3. The information processing apparatus according to claim 1, further comprising:
a scene searching unit which searches the moving image contents for the scene based on the scene searching key;
a metadata generating unit which generates metadata based on a search result of the scene searching unit; and
a metadata storing unit which stores, in the metadata management server via the network, the metadata generated by the metadata generating unit.

4. The information processing apparatus according to claim 3, wherein the scene searching unit searches the moving image contents for the scene matching the scene searching key according to pattern matching, and
the metadata generating unit generates the metadata based on information indicating the searched scene.

5. The information processing apparatus according to claim 4, further comprising:
a determination result obtaining unit which obtains, from the metadata management server, determination information indicating whether or not the metadata corresponding to the scene searching key exist in the metadata management server,
wherein, when the determination result obtaining unit receives, from the metadata management server, the determination information indicating that the metadata based on the scene searching key does not exist, the scene searching unit searches for, based on the scene searching key, a specific scene from the moving image contents.

6. The information processing apparatus according to claim 2, wherein the scene extracting unit extracts, based on the metadata obtained by the metadata obtaining unit, one or more scenes from the moving image contents stored in the storing unit, and includes a user interface which presents the extracted one or more scenes such that a user can select each of the scenes, and
the reproducing unit reproduces the moving image contents stored in the storing unit from the scene selected by the user via the user interface.

7. A metadata management server, comprising:
a network connection unit connectable, via a network, to one or more client devices which process moving image contents;
a database configured to store, as metadata, a search result of searching moving image contents for a scene by a predetermined scene searching key;
a scene searching key receiving unit which receives, from the client devices, a scene searching key of the moving image contents;
a metadata searching unit which searches the database for metadata by the scene searching key received by the scene searching key receiving unit; and
a metadata transmitting unit which transmits, to the client devices, the metadata searched for by the metadata searching unit.

8. The metadata management server according to claim 7, further comprising:
a determination result transmitting unit configured to notify the client devices of a search determination result indicating whether the database includes metadata corresponding to the scene searching key received from the client devices,
wherein, after the determination result transmitting unit notifies the client devices of the search determination result, when a request for obtaining metadata is received from the client devices which transmits the scene searching key, the metadata transmitting unit transmits, to the client devices, the metadata searched for by the metadata searching unit.

9. The metadata management server according to claim 7, further comprising:
a database storing unit which obtains, from the client devices, a search result of searching the moving image contents for a scene by a predetermined scene searching key, and stores the obtained metadata in the database.

10. A metadata management method for a system in which a metadata management server is coupled, via a network, to a plurality of client devices processing moving image contents, the metadata management method comprising:
transmitting, from the client devices to the metadata management server via the network, a scene searching key for searching for a specific scene from moving image contents processed by the client devices;
searching a database of the metadata management server for the scene searching key received from the client devices; and
transmitting metadata in the database from the metadata management server to the client devices, the metadata corresponding to the scene searching key.

11. The metadata management method according to claim 10, further comprising:
extracting, by the client devices, a scene from the moving image contents, the scene being specified by the metadata obtained from the metadata management server; and
reproducing the scene extracted from the moving image contents.

12. The metadata management method according to claim 11, further comprising:
searching, by the client devices, the moving image contents for a scene which matches the scene searching key;
transmitting, from the client devices to the metadata management server, metadata generated based on a search result; and
storing, in the metadata management server, the metadata received from the client devices.
